(19) United States
(12) Patent Application Publication
(10) Pub. No.: US 2026/0202277 A1
(43) Pub. Date: Jul. 16, 2026

(54) VISUAL INDICATOR OF VACUUM PRESSURE IN A PNEUMATIC CIRCUIT

(71) Applicant: COVAL, MONTELIER (FR)

(72) Inventor: Loïc JOGUET-RECCORDON, SOYONS (FR)

(21) Appl. No.: 19/423,817

(22) Filed: Dec. 17, 2025

(30) Foreign Application Priority Data
Dec. 18, 2024 (FR) FR2414456

(51) Int. Cl. G01L 19/08; B25J 15/06

(52) U.S. Cl. CPC G01L 19/08; B25J 15/0616

(57) ABSTRACT

A visual indicator of vacuum pressure in a pneumatic circuit includes a hollow body having a base and a top connected by a side wall having a window near the top; an element for coupling to the pneumatic circuit, the element being secured to the base and opening into the body via a pipe provided in the base; a bellows, which has a first, open end fastened to the base facing the pipe and a second, closed end, and which is deformable between an extended state, in which the second end extends near the top facing the window, and a retracted state, in which the second end extends between the base and the window; and a magnetic attraction device including a first element secured to a front wall of the second end of the bellows and a second element that is secured to the top.

The present invention relates to the field of pneumatic circuits, in particular to vacuum circuits.

### BACKGROUND OF THE INVENTION

Vacuum circuits are used, for example, in the field of handling, in particular in vacuum grippers comprising a vacuum circuit and suction cups which are applied to an outer surface of objects to exert a suction or sucking effect thereon when the suction cups are connected to the vacuum circuit.

To ensure the effectiveness of the suction/sucking effect, it is beneficial to know if the vacuum circuit is operational and if the suction cups are indeed under vacuum pressure.

Visual vacuum indicators of the pressure gauge type are known but are relatively complex, fragile and bulky.

### OBJECT OF THE INVENTION

The object of the invention is in particular to provide a vacuum indicator that is simple, reliable and robust and preferably visible to an operator from a distance.

### SUMMARY OF THE INVENTION

To this end, according to the invention an indicator of vacuum pressure in a pneumatic circuit is provided, comprising: a hollow body having a base and a top which are connected by at least one side wall; an element for coupling to the pneumatic circuit, said element being secured to the base of the body and opening into the body via a pipe provided in the base of the body; a bellows, which has a first, open end fastened to the base facing the pipe and a second, closed end, and which is movable between an extended state, in which the second end is brought closer to the top, and a retracted state, in which the second end is brought closer to the base, the side wall having at least one window for viewing the bellows in one of its states; and a magnetic attraction device comprising a first element secured to a front wall of the second end of the bellows and a second element secured to the top in order to exert a predetermined retaining force on the first element when the bellows is in its extended state.

It is understood that:
the bellows moves from its extended state to its retracted state when the circuit to which the indicator is connected is under vacuum pressure, meaning that the state of the bellows depends on the pressure in said circuit;
the magnetic attraction device defines a force threshold necessary to allow the bellows to be flattened.

Thus, when the circuit to which the indicator is connected is under a vacuum pressure that is insufficient to bring about, on the bellows, a force capable of overcoming the mutual attraction force between the first element and the second element, the bellows is in its extended state and extends facing the window if the window is positioned near the top. By contrast, when the circuit to which the indicator is connected reaches a vacuum pressure that is sufficient to bring about, on the bellows, a force capable of overcoming the mutual attraction force between the first element and the second element, the bellows moves into its retracted state and leaves the window. The power of the magnet producing the magnetic attraction force is determined so that said magnetic attraction force corresponds to the force brought about on the bellows by the nominal operating vacuum pressure of the circuit. It is therefore possible to determine whether or not the circuit is in nominal operation from what can be seen through the window of the indicator according to the invention. This indicator therefore has

a simple structure with few hinged mechanical connections, allowing it to be robust. Moreover, adjusting the indicator is simple since it merely entails selecting a magnet of suitable power.

According to optional features, used individually or fully or partly in combination:
the indicator comprises a resilient element for returning the bellows to its extended state;
the resilient return element is a helical spring extending in the bellows between the base and the front wall of the second end of the bellows;
the second end of the bellows is covered by a piston having a side skirt that is visible through the window when the bellows is in the corresponding state;
the piston constitutes the front wall of the second end of the bellows;
the skirt is arranged to visually contrast with the side wall of the body when the skirt of the piston is visible through the window;
the indicator comprises an electrical contact switch that is fastened in the body in order to be actuated by the skirt when the bellows is in its retracted state;
the first element comprises a ferromagnetic material, and the second element comprises a magnet;
the open end of the bellows resiliently encloses a tubular end piece that projects from the base around the pipe;
the coupling element is an end piece projecting from the base outside the body.

The invention also relates to a gripping device having suction cups, comprising at least one vacuum pressure indicator.

Other features and advantages of the invention will become clear on reading the following description of a particular and non-limiting embodiment of the invention.

### BRIEF DESCRIPTION OF THE DRAWINGS

Reference is made to the accompanying drawings, in which:

FIG. 1 is a schematic view of a vacuum gripper fitted with a visual indicator according to the invention;

FIG. 2 is an axial cross section through a visual indicator according to the invention.

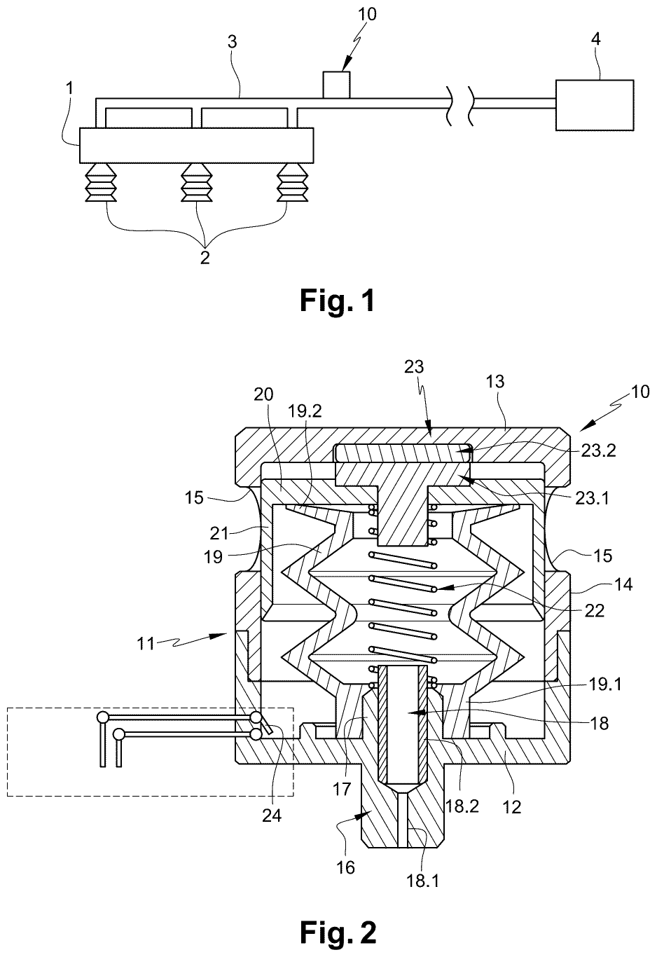

### DETAILED DESCRIPTION OF THE INVENTION

With reference to the drawings, the vacuum gripper comprises a gripping head 1 having suction cups 2 belonging to a pneumatic circuit 3 which connects the suction cups 2 to at least one vacuum source 4 such as one or more air ejectors. The structure and operation of a gripper of this kind are known per se and will not be detailed further here.

The pneumatic circuit 3 has at least one vacuum pressure indicator 10.

The vacuum pressure indicator 10 comprises a hollow body 11 having a base 12 and a top 13 that are interconnected by at least one side wall 14 having at least one window 15 near the top 13. Here, the body 11 is formed by joining together three nested parts, namely a first housing forming the base 12, a tube forming the side wall 14, which has a first end nested in the first housing, and a second housing nested on a second end of the tube to form the top 13.

The base 12 comprises a first end piece 16 and a second end piece 17 that project from two opposite faces of the base 12 coaxially with each other—the first outside the body 11 and the second inside the body 11. A pipe 18 is provided axially in the first end piece 16, the base 12 and the second end piece 17. In this case, the pipe 18 comprises a first portion 18.1 extending in the first end piece 16 and a second portion 18.2 extending in the base 12 and the second end piece 17. Here, the second portion 18.2 accommodates a bushing which projects from the second portion 18.2 and which defines a flow cross section of the second portion 18.2 which, here, is greater than the flow cross section of the first portion 18.1.

The first end piece 16 has a threaded outer surface so that it can be engaged in a tapped hole, which opens into the pneumatic circuit 3, and can thus form an element for coupling the vacuum pressure indicator 10 to the pneumatic circuit 3.

The body 11 contains a bellows 19 which has a first, open end 19.1 fastened to the base 12 facing the pipe 18 and a second, closed end 19.2. The bellows 19, which is made of elastomer in this case, is arranged to be deformable between an extended state, in which the second end 19.2 extends near the top 13 facing the window 15, and a retracted state, in which the second end 19.2 extends between the base 12 and the window 15.

The first end 19.1 of the bellows 19 resiliently encloses the second end piece 17 projecting from the base 12 around the pipe 18.

The second end 19.2 of the bellows 19 is covered by a cap or piston 20 having a side skirt 21 that is visible through the window 15 when the bellows 19 is in its extended state. In this case, the piston 20 is glued to the annular edge of the second end 19.2 of the bellows 19 and constitutes the front wall of the second end 19.2 of the bellows 19. The skirt 21 hangs down along a part of the bellows 19 that is adjacent to the second end 19.2, and is arranged to visually contrast with the side wall 14 of the body 11 when the skirt 21 is visible through the window 15. When the bellows 19 is in its retracted state, the skirt 21 abuts the base 12, meaning that the skirt 21 limits the flattening of the bellows 19.

A spring 22, namely a helical spring, extends in the bellows 19 between the base 12 and the front wall (here the piston 20) of the second end 19.2 of the bellows 19 to form a resilient element for returning the bellows 19 to its extended state. The spring 22 extends in part around the bushing projecting from the second portion 18.2. The spring 22 is selected so as to exert a return force F1. It is noted that the return force exerted by a helical spring depends on both its stiffness and its compression state, the return force F1 being at a maximum when the bellows 19 is in its retracted state (compressed spring 22) and at a minimum when the bellows 19 is in its extended state (relaxed spring 22). Since the skirt 21 limits the flattening of the bellows 19 by abutting the base 12 when

the bellows 19 is in its retracted state, the skirt 21 also limits the flattening of the spring 22.

The indicator 10 further comprises a magnetic attraction device (denoted overall by 23) comprising a first element 23.1 secured to the front wall (here the piston 20) of the second end 19.2 of the bellows 19 and a second element 23.2 that is secured to the top 13 of the body 11 in order to exert, on the first element 23.1, a force for keeping the bellows 19 in its extended state.

Here, the first element 23.1 comprises a pad made of ferromagnetic material glued to the piston 20 so as to project slightly from the front surface thereof towards the top 13, and the second element 23.1 comprises a magnet glued in the wall forming the top 13 so as to also project therein slightly towards the bellows 19. When the bellows 19 is in its extended state, the magnet and the pad are in contact and the magnet exerts a maximum attractive force on the pad, this attraction force being dependent on the power of the magnet. The power of the magnet is selected so as to bring about an attraction force F2, which will be defined later.

Lastly, the indicator 10 comprises an electrical contact switch 24 that is fastened in the body 11 in order to be actuated by the skirt 21 when the bellows 19 is in its retracted state. The electrical contact switch 24 is, for example, connected to an electronic control unit of the gripper (this electronic control unit not being shown), which is, for example, arranged to store time-stamp information on the activation of the electrical contact switch 24 and possibly to send an alert signal to an operator.

During operation, when the gripper is not in use, the pneumatic circuit 3 is at ambient pressure, meaning that the bellows 19 is in its extended state. The skirt 21 is visible in the window 15, and the electrical contact switch 24 is not activated.

At this time, the pad is in contact with the magnet, and the magnet exerts the attraction force F2 on the pad. The spring 22 exerts the return force F1 on the cap 21. The bellows 19 is therefore kept in its extended state by a retaining force F3=F1+F2, which constitutes an activation threshold of the indicator. The stiffness of the bellows 19, which also helps keep the bellows 19 in its extended state, is not discussed here.

The aim is for the indicator 10 to detect a vacuum pressure (or vacuum level) P-in the pneumatic circuit 3. The vacuum pressure P-exerts a sucking force F4 on the bellows 19, said sucking force depending on the surface of the front wall of the bellows 19 exposed to the vacuum pressure.

The power of the magnet is therefore selected so that the retaining force F3 is less than the sucking force F4 corresponding to the vacuum pressure P-.

Thus, until the vacuum pressure P- in the pneumatic circuit is reached, the bellows 19 remains in its extended state because the sucking force is less than the retaining force F3.

By contrast, as soon as the vacuum pressure P- in the pneumatic circuit is reached, the bellows 19 moves from its extended state to its state since the sucking force F4 is greater than the retaining force F3. It is known that the return force F1 increases as the spring 22 is compressed, but at the same time the magnetic attraction force F2 decreases very rapidly as the air gap between the pad and the magnet increases. When the skirt 21 abuts the base 12, the bellows 19 has reached its retracted state. In the process, the skirt 21 has also activated the electrical contact switch 24.

If the vacuum pressure P- in the pneumatic circuit 3 decreases (i.e. the pressure in the pneumatic circuit 3 increases), the sucking force decreases and the bellows 19 begins to return to its extended state under the action of the spring 22 when the sucking force becomes less than the return force F1.

It is understood that by virtue of the invention, the indicator 10 is activated not gradually but instantly as soon as the vacuum pressure P-is reached.

A spring 22 having a very low stiffness may be selected in order to limit the resistance of the spring 22 to the bellows 19 moving towards its retracted state. If the spring 22 has a very low stiffness, it will be unable to return the bellows 19 to its extended state once the vacuum circuit is substantially at ambient pressure.

It goes without saying that the invention is not limited to the described embodiment but covers any variant falling under the scope of the invention as defined by the claims.

In particular, the structure of the indicator may be different from that described.

In this regard, it is possible to provide a stop that prevents the ferromagnetic pad from touching the magnet when the bellows reaches its extended state, with an air gap thus being provided between them. Bearing in mind that the magnetic attraction force depends on the air gap, adjusting the air gap also allows the magnetic attraction force to be adjusted. This adjustment can be achieved by adjusting the position of the stop and/or of the magnet. By way of example, the outer surface of the magnet is threaded so that it can be screwed into the top of the body to a greater or lesser extent.

The bellows may be blind, the second end of the bellows being closed by a front wall formed in one piece with the rest of the bellows, and the ferromagnetic pad (or the magnet) being fastened directly to the front wall. The bellows therefore may not have a cap or piston.

The bellows may itself contrast with the side wall of the body.

It is not essential for the bellows and/or the skirt of the piston to be made of a contrasting material.

The piston may be made of ferromagnetic or magnetised material so that it itself forms one of the elements of the magnetic attraction device.

The ferromagnetic pad may be borne by the body, and the magnet by the second end of the bellows.

Using an electrical contact switch is optional.

Using a resilient return member is optional, or said member may be in a different form from that described, for example a tension spring extending between the piston and the top of the body. The bellows may have a resilience that allows it to return to its extended state by itself.

The end piece for connecting the indicator to the pneumatic circuit may also be an instant-coupling end piece or a threaded end piece.

The indicator may be mounted at any point of the pneumatic circuit, i.e. on any element of the circuit such as a connecting element (duct, pipe, etc.) or an end element (in the application shown, for example, the indicator can be mounted directly on a suction cup 2). Each suction cup 2 could thus be equipped with an indicator according to the invention for checking that the suction cup is functioning properly.

It is conceivable to arrange the window on the lower part of the body of the indicator. It is also possible to provide two windows (top and bottom) together with a two-coloured piston (red at the top and green at the bottom, for example).

The indicator of the invention may be used for applications other than handling and more generally in any pneumatic installation or machine in which detecting a vacuum pressure is beneficial. In the embodiment described, the presence of the vacuum pressure is information indicating that the gripper is functioning properly. The indicator of the invention may be used in the same manner in an installation or machine in which the presence of a vacuum pressure indicates a fault.

The side wall 14 has at least one window 15 for viewing the bellows 19 in one of its states. “Bellows” is used herein to mean the bellows itself or any element secured to the movable end of the bellows. The piston constitutes such an element, and so too would a cover, etc.

1. Visual indicator of vacuum pressure in a pneumatic circuit, comprising:
a hollow body having a base and a top which are connected by at least one side wall;
an element for coupling to the pneumatic circuit, said element being secured to the base of the body and opening into the body via a pipe provided in the base of the body;
a bellows, which has a first, open end fastened to the base facing the pipe and a second, closed end, and which is movable between an extended state, in which the second end is brought closer to the top, and a retracted state, in which the second end is brought closer to the base, the side wall having at least one window for viewing the bellows in one of its states; and
a magnetic attraction device comprising a first element secured to a front wall of the second end of the bellows and a second element that is secured to the top in order to exert a predetermined retaining force on the first element when the bellows is in its extended state.

2. The indicator according to claim 1, comprising a resilient element for returning the bellows to its extended state.

3. The indicator according to claim 2, wherein the resilient return element is a helical spring extending in the bellows between the base and the front wall of the second end of the bellows.

4. The indicator according to claim 1, wherein the second end of the bellows is covered by a piston having a side skirt that is visible through the window when the bellows is in the corresponding state.

5. The indicator according to claim 4, wherein the piston constitutes the front wall of the second end of the bellows.

6. The indicator according to claim 4, wherein the skirt is arranged to visually contrast with the side wall of the body when the skirt of the piston is visible through the window.

7. The indicator according to claim 4, comprising an electrical contact switch that is fastened in the body in order to be actuated by the skirt when the bellows is in its retracted state.

8. The indicator according to claim 1, wherein the first element comprises a ferromagnetic material and the second element comprises a magnet.

9. The indicator according to claim 1, wherein the open end of the bellows resiliently encloses a tubular end piece that projects from the base around the pipe.

10. The indicator according to claim 1, wherein the coupling element is an end piece projecting from the base outside the body.

11. A gripping device having suction cups belonging to a pneumatic circuit to which at least one indicator according to any of the preceding claims is coupled.
